(19) United States
(12) Patent Application Publication
(10) Pub. No.: US 2023/0142414 A1
(43) Pub. Date: May 11, 2023

(54) SYSTEMS AND METHODS FOR GENERATING DYNAMIC EDUCATIONAL CONTENT SETS

(71) Applicant: Pencil Learning Technologies, Inc., Palo Alto, CA (US)

(72) Inventors: Amogh Asgekar, Palo Alto, CA (US); Ayush Agarwal, San Francisco, CA (US)

(73) Assignee: Pencil Learning Technologies, Inc., Palo Alto, CA (US)

(21) Appl. No.: 17/523,831

(22) Filed: Nov. 10, 2021

(51) Int. Cl. G09B 5/12; H04L 29/08

(52) U.S. Cl. CPC G09B 5/12; H04L 67/30

(57) ABSTRACT

The present disclosure provides systems and methods for generating dynamic content sets based on real-time feedback. A system can maintain atomic units of content. The atomic units of content can have a topic and a complexity. The system can maintain a client device profile comprising response records for at least one atomic unit of content. The system can receive, from a provider computing device, instructions to generate a dynamic set of content. The instructions can specify a topic distribution and a complexity distribution. The system can generate, based on the instructions, the dynamic set of content as a subset of the plurality of atomic units of content. The system can present an item of the dynamic set of content responsive to receiving a request for the dynamic set of content from the client device.

### BACKGROUND

Educators use tedious, manual processes to create, format, and arrange teaching media into sets as part of a lesson plan. It can be challenging to efficiently create, format, and arrange content for many different users.

In some implementations, educators manually curate sets of content for students or other users. These sets of content can include, for example, problem sets, quizzes, exams, or lesson resources. Most educators or educational content providers disseminate material in the form of large, monolithic documents or online courses that contain statically ordered content that is based on the judgement of the content creator for learning outcomes. Such content sets lead to information decay, as manually updating content is a tedious exercise, which can often produce inconsistent or ineffective results. A static ordering can further prevent the content from being re-ordered or selectively edited based on the requirements of the learners (e.g., students).

### SUMMARY

The systems and methods of this technical solution solve these and other issues by automatically generating dynamic sets of content to achieve desired outcomes for educators and students. To do so, the systems and methods of this technical solution can generate a separate assignment for each student in a class (e.g., a group of students, etc.), based on a reference assignment created for a subject. The systems and methods described herein can further create a dynamically changing assignment for each student that updates based on answers provided to questions and historical question performance for each individual user. The sets of content automatically generated by the systems and methods described herein can include dynamically changing sets of questions or notes. The sets of questions or notes can be generated by replicating attributes of an existing set of content created by an educational content provider, or by collating content ordered by learning dependencies following an expected distribution of topics and difficulties as expressed by the educator. For example, in some implementations, a student could direct the system to generate a practice quiz with related study materials, or even an entire lesson set from disparate teaching materials found on the Internet or in a library of materials. The system may generate such sets dynamically, based on historical data including question performance data for each user, and without mimicking an existing question set or using manually created templates.

At least one aspect of the present disclosure is directed to a method of generating dynamic content sets based on real-time feedback. The method can be performed, for example, by a computing system comprising one or more processors coupled to memory. The method can include maintaining a plurality of atomic units of content. Each atomic unit of content can correspond to a topic and a complexity score. The method can include maintaining a client device profile corresponding to a client device, and/or a client user of a device (e.g. the profile may be device specific, user specific, or both). The client device profile can include historical response records for at least one of the plurality of atomic units of content. The method can include receiving, from a provider computing device, instructions for generation of a dynamic set of content. The instructions can include topic distribution information and complexity distribution information. The method can include generating, based on the instructions comprising the topic distribution information and the complexity distribution information, the dynamic set of content as a subset of the plurality of atomic units of content. The method can include presenting, based on the client device profile, on a display of the client device, an item of the dynamic set of content, responsive to a request for the dynamic set of content received from the client device.

In some implementations, maintaining the plurality of atomic units of content can include receiving, from the provider computing device, a request to add an atomic unit of content. In some implementations, the request can include the atomic unit of content, the topic of the atomic unit of content, and the complexity score of the atomic unit of content. In some implementations, maintaining the plurality of atomic units of content can include storing the atomic unit of content as part of the plurality of atomic units of content. In some implementations, the atomic unit of content can be stored in association with the topic of the atomic unit of content and the complexity score of the atomic unit of content.

In some implementations, the method can include receiving, from the client device, a response to the presentation of the dynamic set of content. In some implementations, the method can include updating, by the one or more processors, the historical response records of the client device profile corresponding to the client device based on the response. In some implementations, the presentation of the dynamic set of content includes a question having a correct answer. In some implementations, receiving the response from the client device can include receiving a provided answer to the question presented on the display of the client device. In some implementations, updating the client device profile can include updating the client device profile to include an indication of whether the provided answer matches the correct answer for the question.

In some implementations receiving the instructions for generation of the dynamic set of content comprises receiving, by the one or more processors, a reference set of atomic units of content from the provider computing device. In some implementations, each of the reference set of atomic units of content can include a respective reference topic, a respective reference complexity score, and a respective content format. In some implementations, generating the dynamic set of content further can include identifying a reference subset of the reference set of atomic units of content. In some implementations, the respective content format of each item of the reference subset can match a question format (e.g. multiple choice, yes/no or true/false, open ended, short-answer, etc.) or other format (e.g. explanatory format, diagrammatic format, etc.). In some implementations, generating the dynamic set of content further can include determining, from the respective reference complexity score of each item of the reference set, a target complexity score distribution and a target duration value. In some implementations, generating the dynamic set of content further can include generating the dynamic set of content by selecting a target subset of the plurality of atomic units of content. In some implementations, the items of the target subset can satisfy the target duration value and the target complexity score distribution.

In some implementations, generating the dynamic set of content is further based on selecting the target subset of the plurality of atomic units of content such that each item of the target subset corresponds to a target topic specified by the provider computing device. In some implementations, receiving the instructions for generation of the dynamic set of content further can include receiving, from the provider computing device, a distribution of topics, a distribution of complexity scores, and an identifier of the client device profile. In some implementations, generating the dynamic set of content can include generating, based on the client device profile, an initial dynamic set of content selected as an initial subset of the plurality of atomic units of content. In some implementations, the items of the initial dynamic set of content can satisfy the distribution of topics and the distribution of complexity scores. In some implementations, generating the dynamic set of content can include presenting the initial dynamic set of content on the display of the client device corresponding to the client device profile.

In some implementations, generating the dynamic set of content can include updating the initial dynamic set of content based on a response to the presentation of the initial dynamic set of content received from the client device. In some implementations, updating the initial dynamic set of content can include updating the distribution of complexity scores based on the response to the presentation of the initial dynamic set of content received from the client device. In some implementations, updating the initial dynamic set of content can include replacing at least one of the initial dynamic set of content based on the updated distribution of complexity scores.

At least one other aspect of the present disclosure is directed to a system for generating dynamic content sets based on real-time feedback. The system can include, for example, one or more processors coupled to memory. The system can maintain a plurality of atomic units of content. Each atomic unit of content can correspond to a topic and a complexity score. The system can maintain a client device profile corresponding to a client device. The client device profile can include historical response records for at least one of the plurality of atomic units of content. The system can receive, from a provider computing device, instructions for generation of a dynamic set of content. The instructions can include topic distribution information and complexity distribution information. The system can generate, based on the instructions comprising the topic distribution information and the complexity distribution information, the dynamic set of content as a subset of the plurality of atomic units of content. The system can present, based on the client device profile, on a display of the client device, an item of the dynamic set of content, responsive to a request for the dynamic set of content received from the client device.

In some implementations, the system can maintain the plurality of atomic units of content by receiving, from the provider computing device, a request to add an atomic unit of content. In some implementations, the request can include the atomic unit of content, the topic of the atomic unit of content, and the complexity score of the atomic unit of content. In some implementations, the system can maintain the plurality of atomic units of content by storing the atomic unit of content as part of the plurality of atomic units of content. In some implementations, the atomic unit of content can be stored in association with the topic of the atomic unit of content and the complexity score of the atomic unit of content.

In some implementations, the system can receive, from the client device, a response to the presentation of the dynamic set of content. In some implementations, the system can update the historical response records of the client device profile corresponding to the client device based on the response. In some implementations, the presentation of the dynamic set of content includes a question having a correct answer. In some implementations, the system can receive the response from the client device by receiving a provided answer to the question presented on the display of the client device. In some implementations, the system can update the client device profile by updating the client device profile to include an indication of whether the provided answer matches the correct answer for the question.

In some implementations, the system can receive the instructions for generation of the dynamic set of content by receiving a reference set of atomic units of content from the provider computing device. In some implementations, each of the reference sets of atomic units of content can include a respective reference topic, a respective reference complexity score, and a respective content format. In some implementations, system can generate the dynamic set of content by identifying a reference subset of the reference set of atomic units of content. In some implementations, the respective content format of each item of the reference subset can match a question format. In some implementations, the system can generate the dynamic set of content by determining, from the respective reference complexity score of each item of the reference set, a target complexity score distribution and a target duration value. In some implementations, the system can generate the dynamic set of content by generating the dynamic set of content by selecting a target subset of the plurality of atomic units of content. In some implementations, the items of the target subset can satisfy the target duration value and the target complexity score distribution.

In some implementations, the system can generate the dynamic set of content further based on selecting the target subset of the plurality of atomic units of content such that each item of the target subset corresponds to a target topic specified by the provider computing device. In some implementations, the system can receive the instructions for generation of the dynamic set of content by receiving, from the provider computing device, a distribution of topics, a distribution of complexity scores, and an identifier of the client device profile. In some implementations, the system can generate the dynamic set of content by generating, based on the client device profile, an initial dynamic set of content selected as an initial subset of the plurality of atomic units of content. In some implementations, the items of the initial dynamic set of content can satisfy the distribution of topics and the distribution of complexity scores. In some implementations, the system can generate the dynamic set of content by presenting the initial dynamic set of content on the display of the client device corresponding to the client device profile.

In some implementations, the system can generate the dynamic set of content by updating the initial dynamic set of content based on a response to the presentation of the initial dynamic set of content received from the client device. For example, in some implementations, the system can generate the set of content according to historical performance data for previously presented content items (e.g. positive performance data; negative performance data; performance data indicating users viewed the content fully, correctly answered questions, or performed other actions, etc.). In some implementations, the system can update the initial dynamic set of content by updating the distribution of complexity scores based on the response to the presentation of the initial dynamic set of content received from the client device. In some implementations, the system can update the initial dynamic set of content by replacing at least one of the initial dynamic set of content based on the updated distribution of complexity scores.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which may be carried on appropriate carrier media (computer readable media), which may be tangible carrier media (e.g. disks) or intangible carrier media (e.g. communications signals). Aspects may also be implemented using suitable apparatus, which may take the form of programmable computers running computer programs arranged to implement the aspect. As used in the specification and in the claims, the singular form of ‘a’, ‘an’, and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1A is a block diagram depicting an embodiment of a network environment comprising a client device in communication with a server device;

FIG. 1B is a block diagram depicting a cloud computing environment comprising a client device in communication with cloud service providers;

FIGS. 1C and 1D are block diagrams depicting embodiments of computing devices useful in connection with the methods and systems described herein;

FIG. 2 is a block diagram of an example system for generating sets of content based on educational content provider data or based on real-time feedback, in accordance with one or more implementations; and

FIG. 3 illustrates an example flow diagram of a method for generating sets of content based on educational content provider data or based on real-time feedback, in accordance with one or more implementations.

### DETAILED DESCRIPTION

Below are detailed descriptions of various concepts related to, and implementations of, techniques, approaches, methods, apparatuses, and systems for generating dynamic content sets based on real-time feedback. The various concepts introduced above and discussed in greater detail below may be implemented in any of numerous ways, as the described concepts are not limited to any particular manner of implementation. Examples of specific implementations and applications are provided primarily for illustrative purposes.

For purposes of reading the description of the various implementations below, the following descriptions of the sections of the Specification and their respective contents may be helpful:
Section A describes a network environment and computing environment which may be useful for practicing embodiments described herein; and
Section B describes systems and methods for generating dynamic content sets based on real-time feedback.

### A. Computing and Network Environment

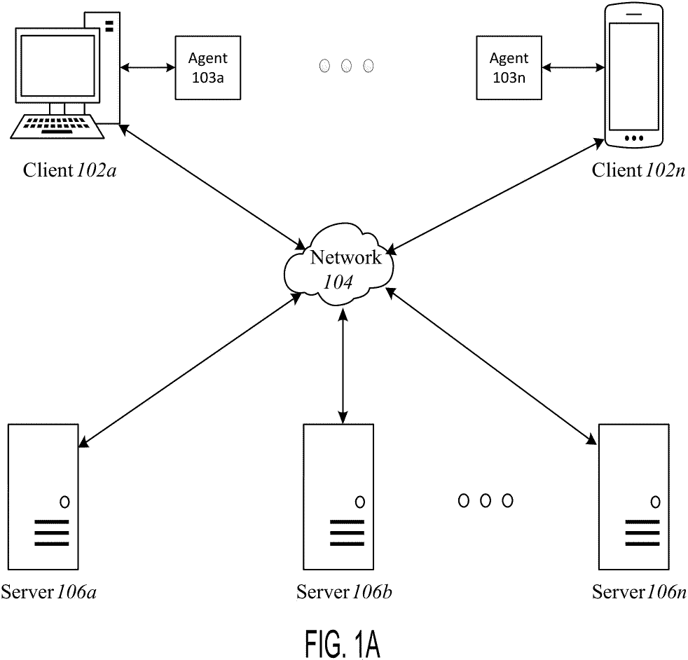

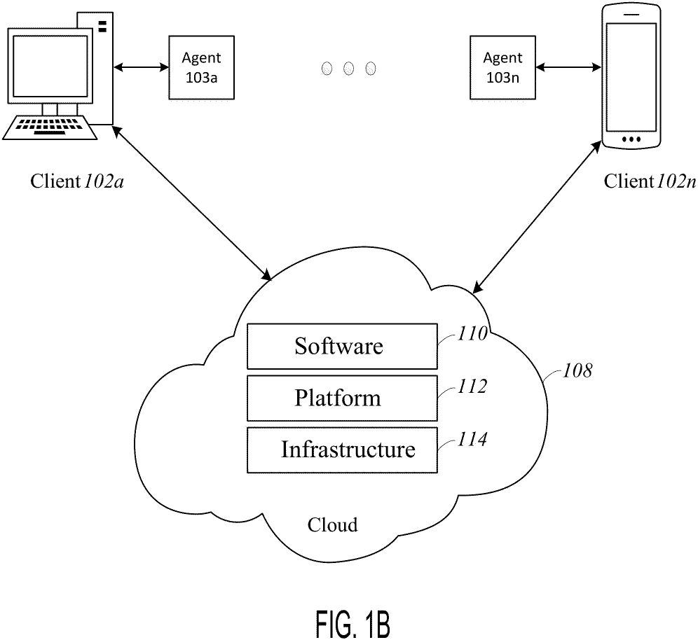

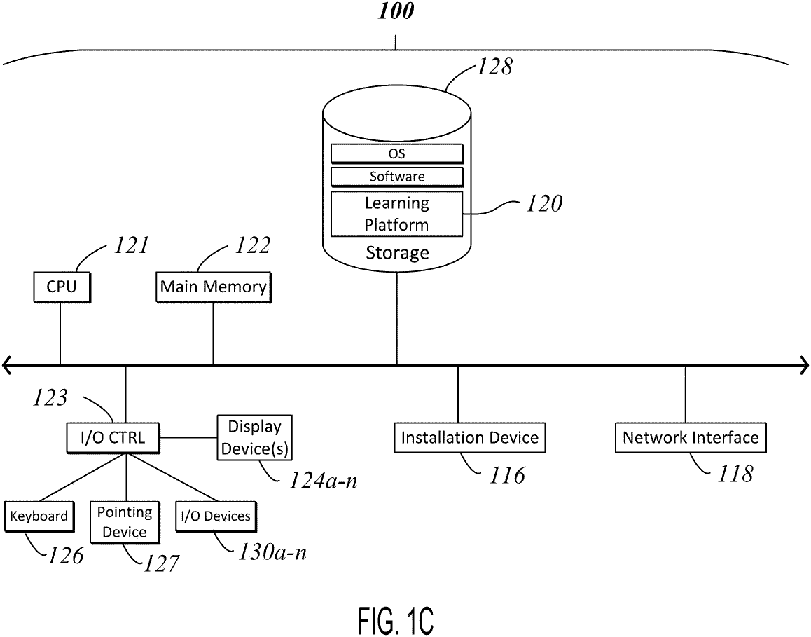

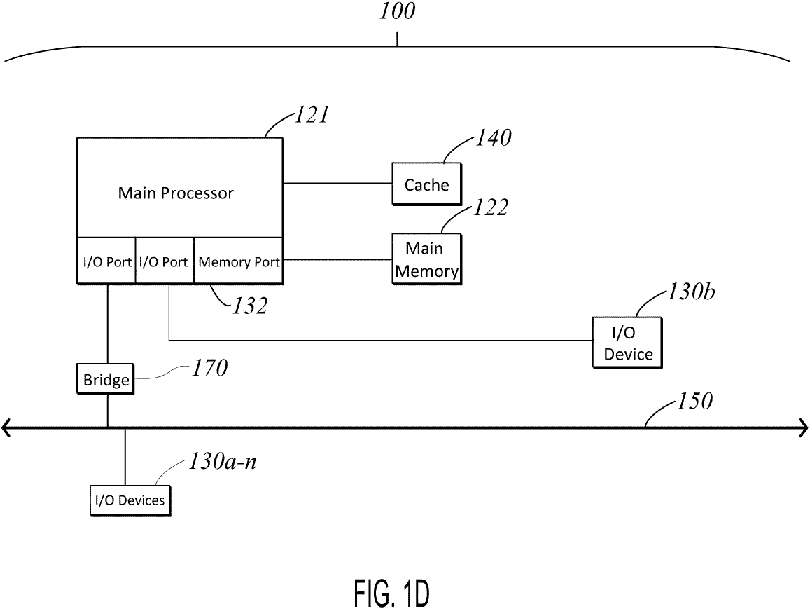

Prior to discussing specific implements of the various aspects of this technical solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more agents 103a-103n and one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generations of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 (not shown) or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous - one or more of the servers 106 or machines 106 can operate according to one type of operating system platform (e.g., WINDOWS NT, manufactured by Microsoft Corp. of Redmond, Washington), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, California; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with respective agents 103a-103n and with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

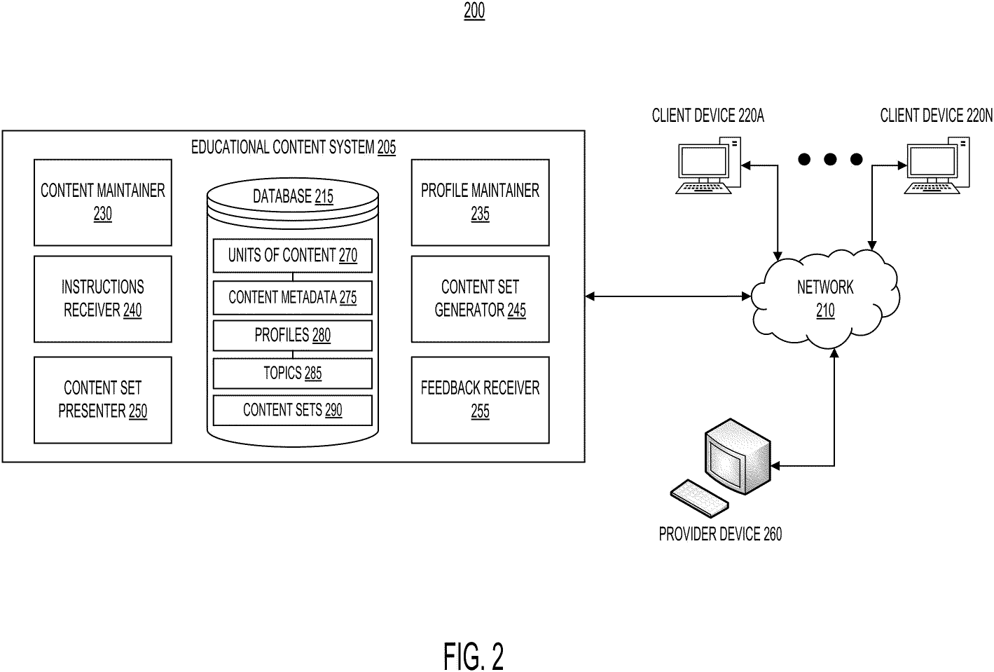

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and learning platform 120, which can implement any of the features of the educational content system 205 described herein below in conjunction with FIG. 2. As shown in FIG. 1D, each computing device 100 may also include additional optional elements, e.g. a memory port 132, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor, those manufactured by International Business Machines of White Plains, New York; or those manufactured by Advanced Micro Devices of Sunnyvale, California. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5, INTEL CORE i7, and INTEL CORE i9.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 132. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provide for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopic. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer’s display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the learning platform 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage devices 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or applications from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include applications developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.1 1a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Florida. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Washington; MAC OS and iOS, manufactured by Apple, Inc. of Cupertino, California; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, California, among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, a PLAYSTATION 4, PLAYSTATION 5, or PLAYSTATION PORTABLE (PSP), or a PLAYSTATION VITA device manufactured by the Sony Corporation of Tokyo, Japan, a NINTENDO DS, NINTENDO 3DS, NINTENDO WII, NINTENDO WII U, or a NINTENDO SWITCH device manufactured by Nintendo Co., Ltd., of Kyoto, Japan, an XBOX 360, an XBOX ONE, an XBOX ONE S, XBOX ONE X, XBOX SERIES S, or an XBOX SERIES X device manufactured by the Microsoft Corporation of Redmond, Washington.

In some embodiments, the computing device 100 is a digital audio player such as the Apple IPOD, IPOD Touch, and IPOD NANO lines of devices, manufactured by Apple Computer of Cupertino, California. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Washington. In other embodiments, the computing device 100 is an eBook reader, e.g. the KINDLE family of devices by Amazon.com, or NOOK family of devices by Barnes & Noble, Inc. of New York City, New York.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Generating Dynamic Content Sets Based on Real-Time Feedback

The systems and methods of this technical solution provide techniques for generating dynamic content sets based on real-time feedback. Educators often manually curate sets of content for students or other users. These sets of content can include, for example, problem sets, quizzes, exams, or lesson resources. Most educators or educational content providers disseminate material in the form of large, monolithic documents or online courses that contain statically ordered content that is based on the judgement of the content creator for learning outcomes. Such content sets lead to information decay, as manually updating content within such static containers is a tedious exercise, which can often produce inconsistent or ineffective results. A static ordering can further prevent the content from being re-ordered or selectively edited based on the requirements of the learners (e.g., students).

The systems and methods of this technical solution solve these and other issues by automatically generating dynamic sets of content to achieve desired outcomes for educators and students. To do so, the systems and methods of this technical solution can generate a separate assignment for each student in a class (e.g., a group of students, etc.), modeled based on a reference assignment created for a subject. The systems and methods described herein can further create a dynamically changing assignment for each student that updates based on answers provided to questions and historical question performance for each individual user. The sets of content automatically generated by the systems and methods described herein can include dynamically changing sets of questions or notes. The sets of questions or notes can be generated by replicating attributes of an existing set of content created by an educational content provider, or by collating content ordered by learning dependencies following an expected distribution of topics and difficulties as expressed by the educator.

The systems and methods of this technical solution can operate from the bottom up by storing atomic units of content, (e.g., a question, a note, other units of content, etc.), which can then be assembled into a “set” in a particular order. The sets of content can either be assigned to students or other users for practicing online or printed into a worksheets, among other delivery methods. The atomic units of content can include, for example, a list of individual fragments, a set of annotations with references to a database of topics, an answer defined as a list of fragments if the content is a question, images, videos, audio segments, simulations, and other metadata. The metadata can include a difficulty value if the content is a question, a grade level for the content (e.g., an education level or age for which the content is suitable, etc.), a source of the content (e.g., if the content was retrieved from a pre-existing source, etc.), custom attributes (e.g., interests, skills, etc.) assigned by an educator, and a time taken to solve if the content is a question, among others.

As described herein above, the atomic units of content can be organized into a set of content, which can be defined as an ordered collection of atomic content units of content (e.g., questions, notes, lessons, etc.). A set can be defined by, for example, a list of identifiers referencing units of content (e.g., stored in tables based on content type, etc.), courses or subjects the set can be attributed to (e.g., course or subject identifiers, etc.), a list of students or users (e.g., client device profile identifiers, etc.) the set has been assigned for, visibility data for the set, and collaboration metadata on who can modify it, among others. The list of students or users can be stored in a database, or as a list of identifiers of client device profiles, as described herein. As further described herein, the sets of content can be generated using various dynamic content set generation techniques. One such technique is set cloning.

Set cloning can refer to a technique for generating a dynamic set of atomic units of content based on a set of content provided by an educator or other provider. Using set cloning, many similar dynamic sets of content can be generated based on the provided set of content. A set cloning technique can include accepting a reference set from a provider. The reference set can include N items of content, of which q are atomic units of content that are questions. Each item in the reference set can be iterated over to identify positions that correspond to questions. Notes can be ignored. Taking the questions in the reference set, the topics associated with the questions and difficulty of the questions can each be aggregated into a topic distribution and a difficulty distribution, respectively. The time taken to solve each question can be summed to a total time taken to solve the set. Using the techniques described in further detail herein, new cloned sets can be generated until a desired number of cloned sets are created that each have similar topic and difficulty distributions. The notes, or other non-question content in the reference set, can then be copied to corresponding positions in each generated cloned set.

Another technique for generating dynamic sets of content involves dynamically updating a set of atomic units of content based on performance from a student. For example, different atomic units of content can be chosen (e.g., from different difficulties, topics, etc.) based on which questions a student or user answers correctly or incorrectly. In some implementations, instead of using a reference set as above, the educator or educational content provider can input a set of subjects, a set of topics, a total time to answer, and a target difficulty distribution, along with a list of students or users that the generated set will be assigned to. An initial set of questions can be generated that satisfies the criteria specified by the educational content provider. The initial set of content can then be accessed by each of the users specified in the list of students.

Once a user answers a question in the set, the remaining questions in the set can be updated based on various criteria. For example, if the user answers the question correctly, the target difficulty distribution can be updated slightly to retrieve questions of higher difficulty. The difficulty distribution can also be updated based on the time taken to answer the question and the expected time for the answered question. Likewise, if the user answered the question incorrectly, the target difficulty distribution can be updated to retrieve questions of lower difficulty. If a user consistently answers questions of a particular topic incorrectly, additional questions from that topic can be added to the target distribution (e.g., by updating the target topic distribution, etc.). The interactions (e.g., answers, other interactions, etc.) from each of the students that access the generated set of content can be recorded and stored in corresponding client device profiles. The educational content provider can then access and perform statistical analysis on the interaction data.

Thus, the systems and methods described herein provide improved generation of teaching materials by automatically generating teaching materials tailored to the needs of specific students, to particular lesson plans, and to particular learning goals. Further, the systems and methods described herein can automatically update lists of content on a per-student basis based on a student’s individual performance, and can rapidly adjust or update old teaching materials with new content that satisfies target difficulty and topic distributions. Further details of techniques used to generate dynamic sets of content are described below.

Referring now to FIG. 2, illustrated is a block diagram of an example system 200 for generating sets of content based on educational content provider data or based on real-time feedback. The system 200 can include at least one educational content system 205, at least one network 210, one or more client devices 220A-220N (sometimes generally referred to as client device(s) 220), and at least one provider device 260. The educational content system 205 can include at least one content maintainer 230, at least one profile maintainer 235, at least one instructions receiver 240, at least one content set generator 245, at least one content set presenter 250, at least one feedback receiver 255, and at least one database 215. The database 215 can include one or more units of content 270, content metadata 275, one or more profiles 280, performance data 285, and one or more content sets 290. In some implementations, the database 215 can be external to the educational content system 205, for example, as a part of a cloud computing system or an external computing device in communication with the devices (e.g., the educational content system 205, the client devices 220, the provider device 260, etc.) of the system 200 via the network 210.

Each of the components (e.g., the educational content system 205, the network 210, the client devices 220, the provider device 260, the content maintainer 230, the profile maintainer 235, the instructions receiver 240, the content set generator 245, the content set presenter 250, the feedback receiver 255, the database 215, etc.) of the system 200 can be implemented using the hardware components or a combination of software with the hardware components of a computing system, such as the computing system 100 detailed herein in conjunction with FIGS. 1A-1D, or any other computing system described herein. Each of the components of the educational content system 205 can perform any of the functionalities detailed herein.

The educational content system 205 can include at least one processor and a memory, e.g., a processing circuit. The memory can store processor-executable instructions that, when executed by the processor, cause the processor to perform one or more of the operations described herein. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The educational content system 205 can include one or more computing devices or servers that can perform various functions as described herein. The educational content system 205 can include any or all of the components and perform any or all of the functions of the computer system 100 described herein in conjunction with FIGS. 1A-1D.

The network 210 can include computer networks such as the Internet, local, wide, metro or other area networks, intranets, satellite networks, other computer networks such as voice or data mobile phone communication networks, and combinations thereof. The educational content system 205 (and the components thereof) of the system 200 can communicate via the network 210, for example, with one or more client devices 220 or with the provider device 260. The network 210 may be any form of computer network that can relay information between the educational content system 205, the one or more client devices 220, and one or more information sources, such as web servers or external databases, amongst others. In some implementations, the network 210 may include the Internet and/or other types of data networks, such as a local area network (LAN), a wide area network (WAN), a cellular network, a satellite network, or other types of data networks. The network 210 may also include any number of computing devices (e.g., computers, servers, routers, network switches, etc.) that are configured to receive and/or transmit data within the network 210. The network 210 may further include any number of hardwired and/or wireless connections. Any or all of the computing devices described herein (e.g., the educational content system 205, the one or more client devices 220, the provider device 260, the computer system 100, etc.) may communicate wirelessly (e.g., via WiFi, cellular, radio, etc.) with a transceiver that is hardwired (e.g., via a fiber optic cable, a CAT5 cable, etc.) to other computing devices in the network 210. Any or all of the computing devices described herein (e.g., the educational content system 205, the one or more client devices 220, the provider device 260, the computer system 100, etc.) may also communicate wirelessly with the computing devices of the network 210 via a proxy device (e.g., a router, network switch, or gateway). In some implementations, the network 210 can be similar to or can include the network 104 or the cloud 108 described herein above in conjunction with FIGS. 1A and 1B.

Each of the client devices 220 can include at least one processor and a memory, e.g., a processing circuit. The memory can store processor-executable instructions that, when executed by the processor, cause the processor to perform one or more of the operations described herein. The processor can include a microprocessor, an application-specific integrated circuit (ASIC), a field-programmable gate array (FPGA), etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language. The client devices 220 can include one or more computing devices or servers that can perform various functions as described herein. The one or more client devices 220 can include any or all of the components and perform any or all of the functions of the computer system 100 described herein in conjunction with FIGS. 1A-1D. The client devices 220 can be, or can be similar to, the client devices 102 described herein above in conjunction with FIGS. 1A-1D.

Each client device 220 can include, but is not limited to, a television device, a mobile device, smart phone, personal computer, a laptop, a gaming device, a kiosk, or any other type of computing device. Each client device 220 can be implemented using hardware or a combination of software and hardware. Each client device 220 can include a display device that can provide visual information, such as information presented as a result of executing instructions stored in the memory of the client device 220, or instructions provided by the educational content system 205 via the network 110, or instructions provided by any other computing device described herein. The display device can include an liquid-crystal display (LCD) device, an organic light-emitting diode (OLED) display, a light-emitting diode (LED) display, a bi-stable display (e.g., e-ink, etc.), amongst others. The display device can present one or more user interfaces on various regions of the display in accordance with the implementations described herein. In some implementations, the display device can include interactive elements, such as capacitive or resistive touch sensors. Thus, the display device can be an interactive display (e.g., a touchscreen, etc.), and can include one or more input/output (I/O) devices or interfaces. Each client device 220 can further include or be in communication with (e.g., via a communications bus coupled to the processors of the client devices 220, etc.) one or more input devices, such as a mouse, a keyboard, or digital keypad, among others. The display can be used to present one or more applications as described herein, such as web browsers or native applications. The display can include a border region (e.g., side border, top border, bottom border). The inputs received via the input/output devices (e.g., touchscreen, mouse, keyboard, etc.) can be detected by one or more event listeners (e.g., of an application executing on the client device 220 or of an operating system, etc.), which can indicate interactions with one or more user interface elements presented on the display device of the client devices 220. The interactions can result in interaction data, which can be stored and transmitted by the processing circuitry of the client device 220 to other computing devices, such as those in communication with the client devices 220. The interaction data can include, for example, interaction coordinates, an interaction type (e.g., click, swipe, scroll, tap, etc.), and an indication of an actionable object with which the interaction occurred. Thus, each client device 220 can enable a user to interact with and/or select one or more actionable objects presented as part of graphical user interfaces to carry out various functionalities as described herein.

The client devices 220 can each execute one or more client applications, such as a web browser or a native application that presents educational content provided by the educational content system 205. The one or more client applications can cause the display device of one or more client devices 220 to present a user interface that includes educational content, such as questions, notes, lessons, presentation slides, word documents, online questions, or electronic textbooks, among others. The application can be a web application (e.g., provided by the educational content system 205 via the network 210, etc.), a native application, an operating system resource, or some other form of executable instructions. In some implementations, the client application can include a local application (e.g., local to a client device 220), hosted application, Software as a Service (SaaS) application, virtual application, mobile application, and other forms of content. In some implementations, the application can include or correspond to applications provided by remote servers or third party servers. In some implementations, the application can access the units of content 270, which can be maintained in the database 215, and generate a user interface that displays one or more of the units of content 270, such as the units of content 270 that form a content set 290, on the display device of the client device 220. In some implementations, a unit of content 270 can be a multiple-choice question, and the user interface generated based on the unit of content 270 can include one or more actionable objects that correspond to multiple-choice question answers presented as part of the question. In some implementations, an actionable object for a unit of content 270 can be a “fill-in-the-blank” box that can accept user input, and transmit the input to the educational content system 205 for storage or further processing. Such actionable objects can include user-selectable hyperlinks, buttons, graphics, videos, images, or other application features that generate a signal that is processed by the application executing on the respective client device 220.

In some implementations, one or more client devices 220 can establish one or more communication sessions with the educational content system 205. The one or more communication systems can each include an application session (e.g., virtual application), an execution session, a desktop session, a hosted desktop session, a terminal services session, a browser session, a remote desktop session, a URL session and/or a remote application session. Each communication session can include encrypted and/or secure sessions, which can include an encrypted file, encrypted data or traffic.

Each of the client devices 220 can be computing devices configured to communicate via the network 210 to access the units of the content 270, which can form a part of one or more content sets 290. The units of content 270 can be presented on the client device 220, for example, as part of one or more web pages via a web browser, or application resources via a native application executing on the client device 220. When accessing the units of content 270, the client device 220 can execute instructions (e.g., embedded in the native applications, or a script in a web page displaying the units of content 270, or in the units of content 270 themselves, etc.) that cause the client devices to display educational content, which can include questions, notes, lessons, images, video, audio, quizzes, exams, or other types of educational content. As described herein, the client device 220 can transmit one or more requests for educational content, such as a request for a content set 290, to the educational content system 205, and can receive one or more responses that include the requested content.

The responses can include, for example, one or more of the units of content 270 that make up a requested content set 290. An educational content request can include, for example, a request for a lesson, a request for a question, a request for an information resource related to a topic, or a request for information specified in a query, among others. In some implementations, a client device 220 can log in to the educational content system 205 using authentication credentials, such as a username, a password, an authentication key, or another type of authentication technique. The authentication credentials can be associated with a corresponding profile 280, which can be associated with performance data for a particular user. In some implementations, upon accessing the educational content system 205 using the authentication credentials, the client device 220 can display a user interface that indicates sets of content to which the profile 280 is assigned (e.g., to complete within a certain time period, etc.). This user interface can include one or more actionable objects corresponding to an assigned content set 290 that, when selected, cause the client device 220 to transmit a request for the selected content set 290 to the educational content system 205. In some implementations, the user interface can include one or more input interfaces (e.g., a search query box, etc.), that can accept a search query relating to one or more topics or categories, difficulty ratings, and an amount of time. Using these search features, a client device can transmit a query to the educational content system 205 that requests one or more content sets 290 that satisfy the requirements of the query (e.g., the queried topics, difficulty, and time constraints, etc.).

Other information can be transmitted to the educational content system 205. For example, in response to interactions with the various user interface elements displayed in the user interfaces described herein, the client devices 220 can transmit information, such as account information (e.g., changing account parameters, changing login information, etc.), interaction information, selections of question answers, answers to questions, selections of topics, categories, queries for units of content 270 or for one or more content sets 290, or lesson-based information, or other signals to the educational content system 205. Generally, the client devices 220 can request and display educational content received from the educational content system 205. The requests can include, for example, a request to access information from an educational lesson provided by the provider device 260, a request to access a content set 290, a request to access a unit of content 270, or information related to one or more queries provided by the client devices 220. The request can be a hypertext transfer protocol (HTTP or HTTPS) request message, a file transfer protocol (FTP or FTPS) message, an email message, a text message, or any other type of message that can be transmitted via the network 210.

The provider device 260 can include at least one processor and a memory, e.g., a processing circuit. The memory can store processor-executable instructions that, when executed by the processor, cause the processor to perform one or more of the operations described herein. The processor can include a microprocessor, an application-specific integrated circuit (ASIC), a field-programmable gate array (FPGA), etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language. The provider device 260 can include one or more computing devices or servers that can perform various functions as described herein. The provider device 260 can include any or all of the components and perform any or all of the functions of the computer system 100 described herein in conjunction with FIGS. 1A-1D. The client devices 220 can be, or can be similar to, the client devices 102 described herein above in conjunction with FIGS. 1A-1D.

The provider device 260 can be substantially similar to one or more of the client devices 220 described herein above, and can include any of the hardware components of the client devices 220, as well as perform any of the functionalities of the client devices 220 as described herein. In addition, the provider device 260 can communicate with the educational content system 205 to provide content, which can be stored as the one or more units of content 270 as described herein. The provider device 260 can be operated by one or more educators or educational content creators, and can provide the units of content 270, or provide content portions and instructions to generate the units of content 270, to the educational content system 205 via the network 210 in one or more requests to store a unit of content 270. In some implementations, the provider device 260 can transmit one or more portions of the content metadata 275, which can be stored in the database 215 in association with a respective unit of content 270. In some implementations, the provider device 260 can transmit one or more requests to generate or assemble a content set 290.

The request to create a content set 290 can include, for example, a request to generate a cloned set of content 290. A request to generate a cloned set of content 290 can include a reference set, which can include N units of content 270, of which q units of content 270 questions. In some implementations, the reference set in the request generate a cloned content set 290 can be a reference (e.g., an identifier, etc.) to an existing content set 290 stored in the database 215. In some implementations, the request for the cloned content set 290 can include a specified number of “clones” of the reference content set 290 for the educational content system 205 to generate. In response to the request for the one or more cloned content sets 290, the educational content system 205 can transmit a response message that includes one or more references of the generated cloned content sets 290 to the requesting provider device 260. In some implementations, the response message can include the units of content 270 in each of the generated cloned content sets 290.

The request to create a content set 290 can include, for example, a request to generate a content set having particular parameters. For example, the request to generate a content set can specify a content set length (e.g., one or more of a number of questions or notes in the content set 290, a time period to complete the content set 290, etc.), a target difficulty distribution (e.g., overall difficulty of the content set 290, arrangement of difficulty across the content set 290, etc.), a target topic distribution (e.g., one or more topics for each question or range of questions, a set of topics to be covered by the content set 290, etc.), and a set of subjects (e.g., one or more topic categories, etc.), among others. In some implementations, the target topic distribution can specify a target hierarchy for the target topic distribution. For example, the target topic distribution can specify that a certain number of questions should correspond to one or more specified levels in the target hierarchy. In response to the request to generate the one or more content sets 290, the educational content system 205 can transmit a response message that includes one or more references of the generated cloned content sets 290 to the requesting provider device 260. In some implementations, the response message can include the units of content 270 in each of the generated cloned content sets 290. In some implementations, the requests for the content sets 290 described herein can include one or more identifiers of user identifiers (e.g., student identifiers, etc.), to which the content sets 290 will be assigned. For example, the request to generate one or more content sets 290 can include a list of identifiers of one or more profiles 280, which can correspond respectively to a student or user of the educational content system 205 (e.g., that accesses the educational content system 205 via the client devices 220 as described herein, etc.).

In some implementations, the provider device 260 can execute one or more applications, such as a web browser, that presents a user interface that allows an educator or another user to transmit units of content 270 to the educational content system 205. The user interface can include one or more features (e.g., actionable objects, other user interface elements, etc.) that allow the educator to request a content set 290, as described herein above. The user interfaces presented on the display device of the provider device 260 can provide a user with access to each of the content sets 290, the units of content 270, and the content metadata 275. In some implementations, the provider device 260 can access one or more of the profiles 280 and associated performance data 285. For example, the provider device 260 can transmit one or more requests for performance data 285 corresponding to one or more profiles 280 that have accessed the content sets 290 generated based on requests from the provider device 260. This allows a provider device 260 to track and display the performance data 285 of individual profiles 280 that are part of a class or other learning group that is assigned the content sets 290. In some implementations, the provider device 260 can access the profiles 280, the performance data 285, the content sets 290, the units of content 270, and the content metadata 275, which the provider device 260 is authorized to access (e.g., via an authorization look-up table maintained at the educational content system 205, etc.). For example, the provider device 260 can access the functionality of the educational content system 205 by first entering authentication credentials or other identification information that identifies an account of the provider device 260, which can be maintained by the educational content system 205. The account can be associated with certain content sets 290, units of content 270, content metadata 275, profiles 280, and performance data 285, and which can then be accessed by the provider device 260 in response to the authentication credentials.

The database 215 can be a computer-readable memory that can store or maintain any of the information described herein. The database 215 can maintain one or more data structures, which may contain, index, or otherwise store each of the values, pluralities, sets, variables, vectors, numbers, or thresholds described herein. The database 215 can be accessed using one or more memory addresses, index values, or identifiers of any item, structure, or region maintained in the database 215. The database 215 can be accessed by the components of the educational content system 205, or any other computing device described herein, such as the client devices 220 or the provider device 260, via the network 210. In some implementations, the database 215 can be internal to the educational content system 205. In some implementations, the database 215 can exist external to the educational content system 205, and may be accessed via the network 210. The database 215 can be distributed across many different computer systems or storage elements, and may be accessed via the network 210 or a suitable computer bus interface. The educational content system 205 (or the components thereof) can store, in one or more regions of the memory of the educational content system 205, or in the database 215, the results of any or all computations, determinations, selections, identifications, generations, constructions, or calculations in one or more data structures indexed or identified with appropriate values. Any or all values stored in the database 215 may be accessed by any computing device described herein, such as the educational content system 205, to perform any of the functionalities or functions described herein. In some implementations, the database 215 can be similar to or include the storage 128 described herein above in conjunction with FIG. 1C. In some implementations, instead of being internal to the educational content system 205, the database 215 can be a distributed storage medium in a cloud computing system, such as the cloud 108 detailed herein in connection with FIG. 1B.

The database 215 can store one or more units of content 270, which can be provided by one or more provider devices 260, or provided by or retrieved from external content sources (not pictured). In some implementations, the units of content 270 can each be stored in association with a respective identifier (e.g., an authentication credential, a username, etc.) of the educator or user that provided the units of content 270. In some implementations, the units of content 270 can be stored in association with a source of the content (e.g., if the unit of content 270 was provided by or retrieved from an external source, etc.) The units of content 270 can include any form of educational media, such as questions, quizzes, exams, notes, text, images, video, audio, or instructions to display images, or video, among others. The units of content 270 can each be stored in association with one or more tags, topics identifiers, or category identifiers that indicate the type of information provided by the unit of content 270. The topics associated with each unit of content 270 can be sourced from a topic hierarchy having multiple levels. Each level of the topic hierarchy can itself be associated with a particular category or grouping of topics. A unit of content 270 can have one or more fragments, such as an image, one or more words of text data, one or more segments of video, one or more segments of audio, among others, that are each associated with one or more topic identifiers, category identifiers, subject identifiers, or other identifying information. Each unit of content 270 can include an identifier of the type of the unit of content 270 (e.g., a note, a question, etc.). Each unit of content 270 that is a question (e.g., having the question content type, etc.) can be stored in association with a correct answer to the question, which itself can be one or more fragments (e.g., text information, etc.) as described herein. As such, each answer to a question can itself be stored in association with one or more indications of corresponding topic information (e.g., references to topics, subjects, or categories, etc.).

Each unit of content 270 can be stored as individual content items in one or more data structures, and can be stored in association with a timestamp corresponding to the time the unit of content 270 was stored in the database 215. The units of content 270 can have various presentation attributes. For example, images can include presentation attributes such as image height, image width, image format (e.g., BMP, PNG, JPEG, SVG, etc.), image bit-depth, and other image attributes. Presentation attributes for videos can include video duration, video codec, sound codec, and video resolution (e.g., width, height, etc.), closed captioning information (e.g., text content, etc.), among others. Presentation attributes for text can include font type-face, font size, text location, and other information. In some implementations, each unit of content 270 can include an identifier to a different unit of content 270. For example, a unit of content 270 can include instructions that cause the unit of content 270 to be presented on an information resource with a second unit of content 270. For example, a unit of content 270 can include one or more “sub-questions,” which can be questions stored as units of content 270 embedded in or referenced by a particular unit of content 270. In some implementations, the presentation attributes of one or more units of content 270 can specify a relative position of the item of content to the second unit of content 270 when presented on an information resource (e.g., a web page, native application resource, etc.). If a unit of content 270 is a question, the unit of content 270 can include one or more fragments (e.g., an image, one or more words of text data, one or more segments of video, one or more segments of audio, etc.) corresponding to one or more answers to the question. For example, if the question is a multiple-choice question, the unit of content 270 can include a set of answers made up of one or more fragments. The answers can be presented, for example, on a user interface of a client device 220 accessing the unit of content 270, as described herein above.

The database 215 can store or maintain content metadata 275. The content metadata 275 can be respective metadata stored in association with each unit of content 270. The content metadata 275 can include information that identifies a particular unit of content 270, categorizes a particular unit of content 270, or otherwise provides attributes for a particular unit of content 270. For example, content metadata 275 for a unit of content 270 can include a difficulty value if the content is a question, a grade level for the content (e.g., an education level or age for which the content is suitable, etc.), a source of the content (e.g., if the content was retrieved from a pre-existing source, etc.), custom attributes (e.g., interests, skills, etc.) assigned by a provider device 260, and a time taken to solve if the content is a question, among others. The content metadata 375 can be used by the educational content system 205 to generate the content sets 290. In some implementations, the provider device 260 can access and change content metadata 275 for a unit of content 270 by accessing the unit of content 270 in one or more user interfaces, as described herein.

The profiles 280 can correspond to one or more students or users that access the content sets 290. Each of the profiles 280 can be associated with a profile identifier that identifies the profile 280. In general, the profiles can be accessed via one or more of the client devices 220 or the provider device 260 using particular authentication credentials. For example, each profile 280 can be accessed using a particular set of authentication credentials, as described herein. A profile 280 can include information about a user, and can be accessed and modified via one or more of the client devices 220 or the provider 260. The profiles 280 can identify one or more content sets 290 that have been assigned to the user or student corresponding to the account. In some implementations, a profile 280 can be stored in association with a list of courses or lesson plans that can be defined by an educator using a provider device 260 or a client device 220. For example, as described herein above, a provider device 260 can transmit one or more requests to educational content system 205 that cause the educational content system 205 to associate a particular profile 280 with one or more of the content sets 290, thereby assigning the one or more content sets 290 to the profile 280 for completion. As described herein above, the content sets 290 assigned to a profile 280 can be accessed via a client device 220, using appropriate authentication credentials.

The database 215 can store or maintain performance data 285 for each of the profiles 280. The performance data 285 can store information that can be used to assess the overall performance of a student or user (e.g., corresponding to a profile 280, etc.) with respect to the content sets 290. The performance data 285 can store identifiers of the progress (e.g., number of questions answered, number of notes accessed and read, whether a content set has been completed, etc.) for a profile 280. As described herein above, a user or student can access one or more content sets 290 using a client device 220. As a user or student completes (e.g., answers questions, views notes, etc.) a content set 290, the client device 290 can transmit signals to the educational content system 205 that correspond to the overall performance of the student for the content set 290. The performance data 285 of a profile 280 can include indications of questions answered correctly and questions answered incorrectly by a user when completing one or more content sets 290. The indications can be stored in association with one or more identifiers of the unit of content 270 (e.g., the question answered correctly or incorrectly, etc.), one or more identifiers of the content metadata 275 for the question (e.g., the topics, categories, subjects, difficulty, etc.), and one or more identifiers of the content set 290 to which the unit of content 270 belongs. In some implementations, the performance data 285 can record an overall number of questions answered correctly (or incorrectly) for a given lesson, topic, category, or any other aspect of the content metadata 275.

The database 215 can store or maintain one or more content sets 290. The content sets 290 can be an ordered list of the units of content 270, and can be assigned to one or more of the profiles 280 as described herein. The content sets 290 can each be defined as an ordered collection of atomic content units of content (e.g., questions, notes, lessons, etc.). A set can be defined by, for example, a list of identifiers referencing the units of content 270 (e.g., stored in tables based on content type, etc.). In some implementations, a content set 290 can be stored in association with one or more association with corresponding metadata, such as the content metadata 275 associated with each unit of content 270 in the content set 290, or with identifiers of courses or subjects the content set 290 can be attributed to (e.g., course or subject identifiers, etc.). A content set 290 can include, or be stored in association with, a list of students or users (e.g., profile 280 identifiers, etc.) that the content set 290 has been assigned to. Each content set 290 can include visibility data, which can specify which users (e.g., accounts of educators or providers, the profiles 280, etc.) can access the content set. In some implementations, each content set 290 can include metadata indicating which users or profiles 280 are authorized to modify the content set 290. A content set 290 can be stored in association with a difficulty distribution of the content, a time taken to complete (e.g., answer each question, read each note, etc.) the entire content set 290, and a topic distribution of the content set 290, among others. Each content set 290 can be assigned a content set identifier that identifies a respective content set 290. As described herein, the educational content system 205 can generate and store content sets 290 as ordered lists of the units of content 270 based on the content metadata 275, the profiles 280, and the performance data 285. Each of the components of the educational content system 205 can access, update, or modify the units of content 270, the content metadata 275, the profiles 280, the performance data 285, or the content sets 295, to carry out functionalities detailed herein.

Referring now to the operations of the educational content system 205, the content maintainer 230 can maintain one or more units of content 270 (sometimes referred to herein as ‘atomic units of content 270’). As described herein above, each unit of content 270 can be stored in association with corresponding content metadata 275, which can include one or more topics of the unit of content 270 and a complexity (or difficulty, etc.) score for the unit of content 270. The content maintainer 230 can receive units of content from external sources via the network 210, such as the provider device 260. The provider device 260 can transmit units of content 270, or one or more fragments (e.g., images, portions of text, videos, audio, etc.) that make up a unit of content 270, in a request to store a unit of content 270 in the database 215. The request can include, for example, a difficulty score for the unit of content 270, one or more topics (e.g., which can be associated with individual fragments of the unit of content 270, etc.) for the unit of content, among other content metadata 275 as described herein.

In some implementations, the content maintainer 230 can transmit instructions (e.g., JavaScript, HTML, other display instructions, etc.) to the provider device 260 that cause the provider device 260 to display a user interface that can accept (e.g., allow a user to provide, etc.) one or more fragments for a unit of content 270. In some implementations, the user interface can accept an entire unit of content 270 from the user (e.g., based on interactions provided at provider device 260, etc.). Upon receiving the fragments or the unit of content, the script can cause the provider device 260 to transmit the fragments or the unit of content 270, and any content metadata 275, to the content maintainer 230 in a request to add the unit of content 270 to the database 215. Upon receiving the request, the content maintainer 230 can store the unit of content 270 in the database 215 in association with any content metadata 275 received in the request. In some implementations, the content maintainer 230 can perform semantic analysis on the fragments of the unit of content 270 to identify one or more topics, subjects, or categories for the unit of content 270, and store those as part of the content metadata 275. If an entire unit of content 270 was provided, the content maintainer 230 can extract one or more fragments (e.g., by modality, portions of text information, etc.), and perform similar semantic analysis on the extracted fragments.

The profile maintainer 235 can maintain the profiles 280, which can correspond to a user, a student, or a client device 220 operated by a user or a student. The profile 280 can be stored in the database 215 in association with the performance data 280, which can include historical response records for answers provided in response to one or more of the units of content 270. In some implementations, the profile maintainer 235 can transmit instructions (e.g., JavaScript, HTML, other display instructions, etc.) to the provider device 260 that cause the provider device 260 to display a user interface that can accept input to generate or update a profile 280. For example, the user interface can include one or more fields that can accept data relating to information about a student, or other identifying information that can be used to create a profile 280. Such information can include, for example, authentication information (e.g., username, password, etc.) that identifies the profile 280. The script can cause the provider device 260 to transmit the profile information to the profile maintainer 235, which can generate a profile 280 using the profile information. Generating a profile 280 can include allocating one or more regions of memory in the database 215 that correspond to the profile 280, and populating said regions with the profile information received from the provider device 260. In some implementations, if the information identifies one or more units of content 270 or one or more content sets 290, the profile maintainer 235 can store identifiers of said units of content 270 or identifiers of said content sets 290 in the region of memory allocated for the profile 280.

The instructions receiver 240 can receive instructions to generate a content set 290 from the provider device 260 or from a client device 220. The instructions can include, for example, information indicating a target topic distribution and information indicating a target complexity distribution. The instructions receiver 240 can transmit user interface instructions transmit instructions (e.g., JavaScript, HTML, other display instructions, etc.) to the provider device 260 or the client device 220 that cause the provider device 260 (or the client device 220) to present one or more user interfaces that accept parameters for the generation of a content set 290. The parameters for the content set can include, for example, a distribution of topics, a distribution of complexity scores. In some implementations, the parameters can include one or more identifiers of one or more profiles 280 to which the generated content set 290 will be assigned. The distribution of topics can specify a list of topics that should be present in the generated content set. In some implementations, the distribution of topics specified at the provider device 260 can specify an order (e.g., a first topic must be presented in the content set before a second topic, etc.) by which units of content 270 having the respective topics should appear in the generated content set 290.

Likewise, the complexity distribution can correspond to a distribution of questions having different difficulties in the content set 290. The complexity distribution can specify, for example, how many units of content 270 having specified difficulty should appear in the generated content set 290. In some implementations, the complexity distribution can specify an order of the difficulty (e.g., a specified number of questions having a first difficulty should appear first, then a specified number of questions having a second difficulty should appear next, etc.). In some implementations, the parameters of the content set 290 can include or request that specified units of content 270 (e.g., specified by an identifier of the unit of content 270, etc.) should appear in the content set 290. The parameters for the generated content set 290 can further specify that the specified unit of content 270 should appear at a requested position in the content set 290 (e.g., when the content set 290 is an ordered set of units of content 270, etc.). The specified units of content 270 requested to be part of the generated content set 290 can include one or more notes, questions, text data, videos, images, or any other educational content. In some implementations, the instructions to generate the content set 290 can include an indication to generate a content set 290 that is automatically updated based on feedback from one or more client devices 220 (e.g., the performance data 285, etc.).

In some implementations, the instructions receiver 240 can receive a reference content set 290 from the provider device 260 or the client device 220. The instructions receiver 240 can generate the target topic distribution and the target complexity distribution for a potential content set 290 (e.g., a content set 290 that will be generated by the educational content system 205, etc.). For example, the instructions receiver 240 can iterate through each unit of content 270 referenced in the reference content set 290 included in the instructions received from the provider device 260 or one or more client devices 220, to identify complexity values and topic references for each unit of content 270 in the reference content set 290. From the topic references (e.g., which can include subject matter references, topic category information, etc.) and the difficulty values associated with each question in the reference set (e.g., for questions, etc.), and the type information (e.g., question, note, etc.) in the reference content set 290, the instructions receiver 240 can generate a topic distribution (e.g., an order, frequency, and density of particular topics appearing in the reference content set 290, etc.) and a difficulty distribution (e.g., an order, frequency, and density of particular question difficulties in the reference content set 290, etc.). In some implementations, the topic distribution generated by the instructions receiver 240 can include a target topics hierarchy, which can specify a number of questions representing topics from different topic hierarchy levels. The instructions receiver 240 can identify each of the duration values of each question in the reference content set 290, and sum each duration value to determine a total duration value to complete all questions in the reference content set 290. The total duration value can be used to generate one or more cloned content sets 290 having similar total duration values, as described herein.

The generated reference topic distribution and the reference difficulty distribution can be stored in association with the reference content set 290 received from the provider device 260 or the one or more client devices 220. The reference topic distribution and the reference difficulty distribution can be used, as described herein, to generate a number of cloned content sets 290 having similar attributes to the reference content set 290. In some implementations, the instructions to generate the one or more cloned sets 290 can include a specified number of cloned content sets 290 to generate. In some implementations, as described herein, the instructions to generate the one or more cloned content sets 290 can include an indication to generate cloned content sets 290 that are automatically updated based on feedback from one or more client devices 220 (e.g., the performance data 285, etc.).

The content set generator 245 can generate a content set 290 based on the instructions received by the instructions receiver 240. The generated content set 290 can be, for example, a subset of the units of content 270 stored in the database 215. For example, as described herein above, a content set can include a list of references to particular units of content 270. The content set generator 245 can generate the content set 290 such that it matches the topic distribution, the difficulty distribution, and the overall duration (e.g., the time taken to complete the set, etc.), specified in the instructions received by the instructions receiver 240. To do so, the content set generator 245 can identify a subset of the units of content 270 matching a topic included in the topic distribution information in the instructions. The target distribution specified in the instructions (e.g., explicitly or derived from a reference content set 290, etc.) can be referred to as the target topic distribution, the difficulty distribution specified in the instructions can be referred to as the target difficulty distribution, and the total duration value specified in instructions can be referred to as the target duration value. The one or more content sets 290 to be generated by the content set generator 245 (e.g., one or more as specified in the instructions, etc.) can be referred to as the target content set(s) 290.

If the instructions specify particular units of content 270 that are to be included in the target content set, the content set generator 245 can first insert references (e.g., identifiers, etc.) to each of the specified units of content 270 into the list of identifiers that form the target content set 290. The content set generator 245 can maintain a current total duration value (e.g., for the units of content 270 currently forming a part of the list of content of the target content set 290, etc.) as a counter. The content set generator 245 can further maintain a difference value between the target duration value for the target content set 290 and the current total duration value. The difference value can be used to select units of content 270 for the target content set 290, such that the target content set 290 conforms (e.g., is within a predetermined tolerance range such as 5%, 10%, 15%, etc.) to the target duration value as specified in the instructions. As described herein above, the topic distribution of a content set 290 can include an order, frequency, or a density of particular topics appearing in the instructions (e.g., either specified directly in the reference content set 290. After allocating the specified units of content 270 to the list of content in the target content set 290, the content set generator 245 can determine an order, frequency, or a density of units of content 270 required to satisfy the topic distribution.

For example, consider a topic distribution that indicates that the target content set 290 should include three units of content 270 of “topic A”, four units of content 270 of “topic B”, and two units of content 270 of “topic C”. Furthering this example, if the specified units of content include one unit of content 270 of “topic A”, two units of content 270 of “topic B,” and two units of content 270 of “topic C”, then the content set generator 245 can store in one or more counters that that, to correspond to the target content distribution, the target content set 290 must also include two more units of content 270 of “topic A”, two more units of content 270 of “topic B”, and zero more units of content 270 of “topic C”. The order of the topics, if specified in the topic distribution, can be applied to the units of content 270 after the appropriate number of units of content 270 has been selected to satisfy the requirements of the target topic distribution. Each of the remaining units of content 270 required to satisfy the topic distribution of the target content set 290 can be referred to as a “slot”, meaning a position in the list of content in the target content set 290 that must be populated with an appropriate (e.g., to satisfy the topic, difficulty, and duration values, etc.) unit of content 270. In some implementations, the units of content 270 can be selected to satisfy one or more levels in a topic hierarchy specified by the target topic distribution. Thus, when the target topic distribution is satisfied by the selected units of content 270, so is the target topic hierarchy at each specified level.

The content set generator 245 can select one or more subsets of units of content 270 for each potential slot (e.g., to satisfy the topic distribution as described herein, etc.) in the list of content for the target content set 290. Furthering this example above, this can include selecting more than two potential units of content 270 of “topic A” to populate the two remaining slots in the list of content for the target content set 290, where the potential units of content 270 can each be associated with different difficulty values. The content set generator 245 can select the potential units of content 270 from the units of content 270 having topic values that match those of the slot of interest (furthering the example above, “topic A”). The content set generator 245 can select subsets of the units of content 270 for each potential slot in the target content set 290. From the subsets of the units of content 270, the content set generator 245 can select units of content 270 for the unpopulated slots of the list of content in the target content set 290 to satisfy the difficulty distribution and the duration value. As described herein above, the content set generator 245 can maintain a running counter that is equal to the total duration of the units of content 270 selected for inclusion in the target content set 290. Thus, using the current duration value of the target content set 290, the content set generator 290 can select units of content 270 from the subsets that allow for population of the unpopulated content slots without exceeding the target duration value (e.g., plus or minus a tolerance amount, such as 1%, 5%, 10%, 15%, etc.).

The units of content 270 can be selected by the content set generator 245 to populate the unpopulated slots in the list of content of the target content set 290 to satisfy the target difficulty distribution. As described herein above, the target difficulty distribution can include an order, a frequency, or a density of particular question difficulties that should appear in the target content set 290. Thus, prior to selecting the units of content 270 based on duration, the content set generator can filter each subset of potential units of content 270 selected for each unpopulated slot to satisfy the difficulty distribution. For example, in some implementations, the difficulty distribution can be specified as particular difficulty values for each position in the target content set 290. In some implementations, the content set generator 245 can filter the potential units of content 270 for each slot in the target content set 290, such that the filtered potential units of content 270 for each are associated with difficulty values specified for that slot. Thus, at this stage in the process, the content set generator 245 can have filtered subsets of units of content 270 that satisfy both the target topic distribution and the target difficulty distribution for potential inclusion in each slot of the target content set 290.

The content set generator 245 can then select units of content 270 for each unpopulated slot in the target content set 290 such that the selected units of content 270 satisfy the duration distribution. For example, if the duration distribution is such that each slot in the content set 290 has a specified duration, then the content set generator 245 can select units of content 270 from the filtered subsets of content that match (e.g., within a predetermined range, such as 1%, 5%, 10%, 15%, etc.) the duration values in the specified duration distribution. If the duration value is specified as a total duration value for the entire set, the content set generator 145 can iterate through each unpopulated slot in the target content set 290, and randomly (e.g., pseudo-randomly using a pseudo-random number generator, etc.) select a unit of content 270 from the filtered subset of content for that slot. The duration value of selected units of content 270 can be added to the current duration value of the target content set 290, and the content set generator 245 can move to the next unpopulated slot in the target content set 290. The content set generator 245 can further the filtered subsets of units of content 270 to remove any units of content 270 that have a duration value that exceeds the remaining duration value of the target content set 290 (e.g., target duration for the target content set 290 minus the current duration value for the target content set 290, etc.). In some implementations, the content set generator 245 can estimate an average duration value for each remaining unpopulated slot in the target content set 290, and further filter each filtered subset of the units of content 270 to remove units of content 270 having duration values that exceed (e.g., within a predetermined range, such as 1%, 5%, 10%, 15%, etc.) the estimated average duration value. The content set generator 245 can then select the units of content 270 for each unpopulated slot as described above.

Once each content slot in the target content set 290 has been populated with a unit of content 270, such that the target topic distribution, target difficulty distribution, and target duration values (or distribution) are satisfied, the content set generator 245 can store the target content set 290 in one or more data structures as part of the content sets 290 in the database 215. The generated content set 290 can be stored in association with a unique identifier, which can be returned to the computing device (e.g., the provider device 260 or one or more client devices 220, etc.) that provided instructions to generate the content set 290. In some implementations, if the instructions received by the instructions receiver 240 indicate that the target content set 290 should be dynamically updated based on feedback information, the content set generator 245 can store a copy of the generated content set 290 in association with each of the profiles 280 specified in the instructions. In some implementations, following the generation of the content set 290, the computing device (e.g., the provider device 260 or one or more client devices 220, etc.) that provided the instructions to generate the content set 290 can modify one or more of the units of content 270 in the generated content set 290. For example, the provider device 260 can access the generated content set 290 via the educational content system 205 using the unique identifier of the generated content set 290, and can modify the order of, or replace, one or more of the units of content 270 in the generated content set 290. The modifications can be made, for example, based on user input to actionable objects in a user interface displayed at the provider device 260. The provider device 260 can transmit the modifications to the education content system 205 via the network 210, and the content set generator 245 can modify the order of, or replace, the one or more units of content 270 in the generated content set 290, and store the modified content set 290 in the database 215.

Thus, each user (e.g., corresponding to a profile 280, etc.) can have a corresponding copy of the generated content set 290. The copies of the generated content set 290 can be initial sets of units of content 270, which can be updated as feedback information is received (e.g., correct or incorrect answers to questions in the content set, etc.). When the copy of the content set 290 is updated based on individual feedback, other copies of the content set 290 assigned to different profiles 280 are not necessarily affected. In implementations where the instructions specify that a number of cloned content sets 290 should be generated, the content set generator 290 can repeat the steps detailed above to generate the specified number of content sets 290. Each cloned content set 290 can be stored in the database in association with the reference content 290, from which the target topic distribution, target difficulty distribution, and target duration values were extracted, as described herein. In some implementations, the instructions can specify that only one or more specified portions of the reference content set (e.g., the topic distribution, the difficulty distribution, or the duration values, etc.) should be cloned, and the rest of the content set parameters can be explicitly specified in the instructions received by the instructions receiver 240.

The content set presenter 250 can present each unit of content 270 in a requested content set 290 on a display of a computing device accessing the educational content system 205 (e.g., one or more of the client devices 220, etc.). As described herein above, a client device 220 can access the educational content system 205 using authentication credentials associated with one of the profiles 280. Upon doing so, the content set presenter 250 can transmit display instructions to the accessing client device 220 that cause the client device 220 to present a user interface listing each content set 290 that is accessible (e.g., stored in association with, assigned as described herein, etc.) by the respective profile 280. Each content set 290 can be associated with an actionable object on the user interface that, when actuated (e.g., by user input to the client device 220, etc.), causes the client device 220 to transmit a request for that content set 290 to the content set presenter 250. In response, the content set presenter 250 can access the requested content set 290 and determine whether the requesting profile 280 has access to the content set 290. If the requesting profile has access to the content set 290, the content set presenter 290 can access the first unit of content 270 (e.g., the first in the ordered list, etc.) in the requested content set 290, and transmit display instructions to the client device 220 that cause the client device 220 to present the accessed unit of content 270 in a user interface, as described herein. If the requesting profile 280 does not have access to the content set 290, the content set presenter 290 can transmit an error message to the requesting client device 220, indicating that the requesting profile 280 does not have permission to access the requested content set 290. The unit of content 270 can be, for example, a question (e.g., a multiple-choice question, a fill-in-the-blank question, etc.) having a correct answer.

The display instructions can cause the unit of content 270 to be displayed in one or user interfaces on the client device 220, such that one or more actionable objects (e.g., buttons or hyperlinks for multiple choice, a field for fill-in-the-blank, etc.) that allows a user to provide a proposed answer to the question. Upon entering in an answer, the display instructions can cause the client device 220 to transmit the proposed answer to the question (e.g., the unit of content 270, etc.) to the educational content system 205. The proposed answer can accompany, for example, a request for the next unit of content 270 in the content set 290.

The feedback receiver 255 can receive the response to the question transmitted by the client device 220. If the response includes a proposed answer to the unit of content 270, the feedback receiver 255 can compare the proposed answer to the correct answer for the unit of content 270. If the proposed answer is the correct answer, the feedback receiver 255 can store an indication that the profile 280 answered the unit of content correctly as part of the performance data 285 for that profile 280. Otherwise, if the proposed answer is not the correct answer, the feedback receiver 255 can store an indication that the user corresponding to the profile 280 answered the unit of content 270 incorrectly as part of the performance data 285 for that profile 280. The indication of an incorrect or a correct answer (as the case may be) can be stored in the performance data 285 as part of a historical response record for that question (e.g., unit of content 270), and any associated metadata (e.g., topic, difficulty, duration, etc.) for that question.

In some implementations, if the content set 290 requested by the client device 220 (e.g., the content set the client device 220 is currently displaying, etc.) is indicated as a content set 290 that should be dynamically updated based on feedback, the feedback receiver 255 can update the content set 290 based on one or more answers to the questions provided by the client device 220. In some implementations, the requested content set 290 can be updated based on the performance data 285 (e.g., including answers to questions in other content sets 290, etc.). For example, if the performance data 285 for the provided content set 290 indicates that a user answers one or more questions having an example “topic A” incorrectly, the feedback receiver 255 can determine that this particular user needs more practice with questions having “topic A”, and update the topic distribution of the remaining content slots in the content set 290 (e.g., and in some implementations, by increasing the number of content slots in the content set 290, etc.) to include at least one more question having “topic A”. To do so, the feedback receiver can select a new unit of content 270 for the content set 290 associated with the profile 280 corresponding to the client device 220 having the topic A, as described herein above (e.g., satisfying the difficulty and duration distribution, etc.). In some implementations, the newly selected unit of content 270 can replace (e.g., at random, or a random question not having the same topic, etc.) another unit of content 270 in the content set 290 for the respective profile 280, effectively providing more exposure to “topic A” for that profile.

In some implementations, in response to receiving an indication of a correct or incorrect answer to a question in the requested content set 290, the feedback receiver 255 can update the target difficulty distribution of the content set 290 corresponding to the respective profile 280. For example, if a client device 220 corresponding to the profile answers too many questions correctly, the feedback receiver 255 can determine that the difficulty may need to be increased for the content set 290, and update the target difficulty values for the content slots in the content set 290. The feedback receiver 255 can then signal the content set generator 245 to populate the remaining (e.g., unanswered, etc.) questions in the particular content set 290 with updated units of content 270 according to the new difficulty distribution. In some implementations, the feedback receiver 255 can select a new unit of content 270 in response to each answer to each question. In some implementations, the new unit of content 270 can replace another unit of content 270 specified for inclusion in the content set 290. After the content set 290 has been updated based on the feedback (if needed), the feedback receiver 255 can cause the content set presenter 250 to transmit the next unit of content 270 in the requested content set 290 to the client device 220, until all questions are answered and all other units of content 270 (e.g., notes, etc.) have been accessed. Once all units of content 270 in the content set have been answered or accessed, the feedback receiver 255 can transmit a message to the client device 220 indicating that the content set 290 has been completed. The feedback receiver 255 can store an indication that the content set 290 has been completed by the respective profile 280 in the performance data 285 for that profile 280.

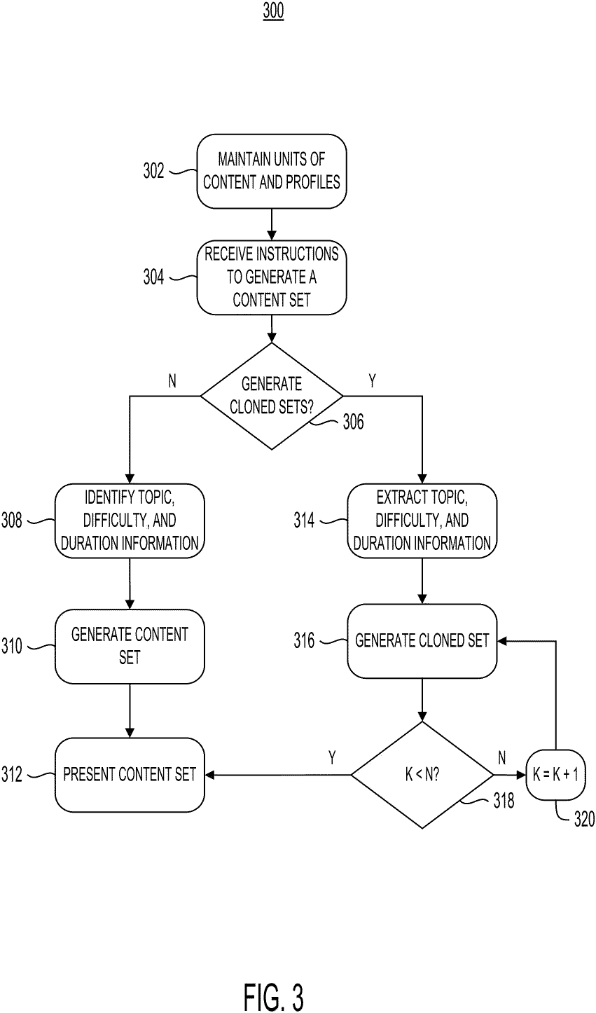

Referring now to FIG. 3, depicted is an example flow diagram of a method 300 for generating sets of content based on educational content provider data or based on real-time feedback. The method 300 can be executed, performed, or otherwise carried out by the educational content system 205, the computer system 100 described herein in conjunction with FIGS. 1A-1D, or any other computing devices described herein. In brief overview of the method 300, an educational content system (e.g., the educational content system 205, etc.) can maintain one or more units of content (e.g., the units of content 270, etc.) and one or more profiles (e.g., the profiles 280, etc.) (STEP 302), receive instructions to generate a content set (e.g., a content set 290, etc.) (STEP 304), determine whether the instructions are to generate one or more cloned content sets (STEP 306), identify topic, difficulty, and duration information (STEP 308), generate a content set (STEP 310), present a requested content set (STEP 312), extract topic, difficulty, and duration information from a reference content set (STEP 314), generate a cloned set (STEP 316), determine whether the number of generated cloned sets k is less the number of specified cloned sets n (STEP 318), and increment the counter register k (STEP 320).

In further detail of the method 300, the educational content system (e.g., the educational content system 205, etc.) can maintain one or more units of content (e.g., the units of content 270, etc.) and one or more profiles (e.g., the profiles 280, etc.) (STEP 302). As described herein above, each unit of content can be stored in association with corresponding content metadata (e.g., the content metadata 275, etc.), which can include one or more topics of the unit of content and a complexity (or difficulty, etc.) score for the unit of content. The educational content system can receive units of content from external sources via a network (e.g., the network 210, etc.), such as a provider device (e.g., the provider device 260, etc.). The provider device can transmit units of content, or one or more fragments (e.g., images, portions of text, videos, audio, etc.) that make up a unit of content, in a request to store a unit of content in a database (e.g., the database 215, etc.). The request can include, for example, a difficulty score for the unit of content, one or more topics (e.g., which can be associated with individual fragments of the unit of content, etc.) for the unit of content, among other content metadata as described herein.

In some implementations, the educational content system can transmit instructions (e.g., JavaScript, HTML, other display instructions, etc.) to the provider device that cause the provider device to display a user interface that can accept (e.g., allow a user to provide, etc.) one or more fragments for a unit of content. In some implementations, the user interface can accept an entire unit of content from the user (e.g., based on interactions provided at provider device, etc.). Upon receiving the fragments or the unit of content, the script can cause the provider device to transmit the fragments or the unit of content, and any content metadata, to the educational content system in a request to add the unit of content to the database. Upon receiving the request, the educational content system can store the unit of content in the database in association with any content metadata received in the request. In some implementations, the educational content system can perform semantic analysis on the fragments of the unit of content to identify one or more topics, subjects, or categories for the unit of content, and store those as part of the content metadata. If an entire unit of content was provided, the educational content system can extract one or more fragments (e.g., by modality, portions of text information, etc.), and perform similar semantic analysis on the extracted fragments.

The educational content system can maintain one or more profiles (e.g., the profiles 280, etc.), which can correspond to a user, a student, or a client device operated by a user or a student. The profile can be stored in the database in association with performance data (e.g., the performance data 280, etc.), which can include historical response records for answers provided in response to one or more of the units of content. In some implementations, the educational content system can transmit instructions (e.g., JavaScript, HTML, other display instructions, etc.) to a provider device that causes the provider device to display a user interface that can accept input to generate or update a profile. For example, the user interface can include one or more fields that can accept data relating to information about a student, or other identifying information that can be used to create a profile. Such information can include, for example, authentication information (e.g., username, password, etc.) that identifies the profile. The script can cause the provider device to transmit the profile information to the educational content system, which can generate a profile using the profile information. Generating a profile can include allocating one or more regions of memory in the database that correspond to the profile, and populating said regions with the profile information received from the provider device. In some implementations, if the information identifies one or more units of content or one or more content sets, the educational content system can store identifiers of said units of content or identifiers of said content sets in the region of memory allocated for the profile.

The educational content system can receive instructions to generate a content set (e.g., a content set 290, etc.) (STEP 304). The educational content system can receive the instructions, for example, from a provider device or from a client device, as described herein. The instructions can include, for example, information indicating a target topic distribution and information indicating a target complexity distribution. The educational content system can transmit user interface instructions transmit instructions (e.g., JavaScript, HTML, other display instructions, etc.) to the provider device or the client device that cause the provider device (or the client device) to present one or more user interfaces that accept parameters for the generation of a content set. The parameters for the content set can include, for example, a distribution of topics, a distribution of complexity scores. In some implementations, the parameters can include one or more identifiers of one or more profiles to which the generated content set will be assigned. The distribution of topics can specify a list of topics that should be present in the generated content set. In some implementations, the distribution of topics specified at the provider device can specify an order (e.g., a first topic must be presented in the content set before a second topic, etc.) by which units of content having the respective topics should appear in the generated content set.

Likewise, the complexity distribution can correspond to a distribution of questions having different difficulties in the content set. The complexity distribution can specify, for example, how many units of content having specified difficulty should appear in the generated content set. In some implementations, the complexity distribution can specify an order of the difficulty (e.g., a specified number of questions having a first difficulty should appear first, then a specified number of questions having a second difficulty should appear next, etc.). In some implementations, the parameters of the content set can include or request that specified units of content (e.g., specified by an identifier of the unit of content, etc.) should appear in the content set. The parameters for the generated content set can further specify that the specified unit of content should appear at a requested position in the content set (e.g., when the content set 290 is an ordered set of units of content 270, etc.). The specified units of content requested to be part of the generated content set can include one or more notes, questions, text data, videos, images, or any other educational content. In some implementations, the instructions to generate the content set can include an indication to generate a content set that is automatically updated based on feedback from one or more client devices (e.g., the performance data, etc.).

The educational content system can determine whether the instructions are to generate one or more cloned content sets (STEP 306). In some implementations, the educational content system can receive a reference content set from the provider device or the client device. The reference content set can be provided, for example, as an identifier of a content set stored in the database maintained by the educational content system. The content set identified in the instructions can include a list of the units of content, from which the educational content system can extract the target topic distribution, the target difficulty distribution, and the target duration information, as in (STEP 314). In some implementations, the educational content system can receive, as part of the instructions, a list of identifiers of units of content stored in the database. The list of identifiers can have a specified order, and thus define a reference set of units of content. If the instructions received from the provider device or the client device does not include a reference set (e.g., an identifier of a content set to clone or a list of identifiers of units of content to treat as a reference set, etc.), the educational content system can proceed to (STEP 308). Otherwise, if the instructions include a request to generate one or more cloned content sets from a provided reference set, the educational content system can perform (STEP 314).

The educational content system can identify topic, difficulty, and duration information (STEP 308). As described herein above, the target topic distribution, the target difficulty distribution, and the target duration (e.g., target time taken to complete the content set, etc.) can be specified in the instructions to generate one or more content sets. The topic distribution and the difficulty distribution information can be stored in association with the instructions received from the provider device or the one or more client devices. The target topic distribution and the difficulty distribution can be used, as described herein, to generate one or more content sets having that satisfy the target topic distribution, the target difficulty distribution, and the target duration values. In some implementations, the instructions to generate the one or more content sets can include a specified number of content sets to generate. In some implementations, as described herein, the instructions to generate the one or more content sets can include an indication to generate one or more content sets that are automatically updated based on feedback from one or more client devices (e.g., the performance data, etc.).

The educational content system can generate a content set (STEP 310). The generated content set can be, for example, a subset of the units of content stored in the database. For example, as described herein above, a content set can include a list of references to particular units of content. The educational content system can generate the content set such that it can match the topic distribution, the difficulty distribution, and the overall duration (e.g., the time taken to complete the set, etc.), specified in the instructions received by the instructions receiver 240. To do so, the educational content system can identify a subset of the units of content matching a topic included in the topic distribution information in the instructions. The target distribution specified in the instructions (e.g., explicitly or derived from a reference content set, etc.) can be referred to as the target topic distribution, the difficulty distribution specified in the instructions can be referred to as the target difficulty distribution, and the total duration value specified in instructions can be referred to as the target duration value. The one or more content sets to be generated by the educational content system (e.g., one or more as specified in the instructions, etc.) can be referred to as the target content set(s).

If the instructions specify particular units of content that are to be included in the target content set, the educational content system can first insert references (e.g., identifiers, etc.) to each of the specified units of content into the list of identifiers that form the target content set. The educational content system can maintain a current total duration value (e.g., for the units of content currently forming a part of the list of content of the target content set, etc.) as a counter. The educational content system can further maintain a difference value between the target duration value for the target content set and the current total duration value. The difference value can be used to select for the target content set, such that the target content set conforms (e.g., is within a predetermined tolerance range such as 5%, 10%, 15%, etc.) to the target duration value as specified in the instructions. As described herein above, the topic distribution of a content set can include an order, frequency, or a density of particular topics appearing in the instructions (e.g., either specified directly in the reference content set. After allocating the specified units of content to the list of content in the target content set, the educational content system can determine an order, frequency, or a density of units of content required to satisfy the topic distribution.

For example, consider a topic distribution that indicates that the target content set should include three units of content of “topic A”, four units of content of “topic B”, and two units of content of “topic C”. Furthering this example, if the specified units of content include one unit of content of “topic A”, two units of content of “topic B”, and two units of content of “topic C”, then the educational content system can store in one or more counters that that, to correspond to the target content distribution, the target content set must also include two more units of content of “topic A”, two more units of content of “topic B”, and zero more units of content of “topic C”. The order of the topics, if specified in the topic distribution, can be applied to the units of content after the appropriate number of units of content has been selected to satisfy the requirements of the target topic distribution. Each of the remaining units of content required to satisfy the topic distribution of the target content set can be referred to as a “slot”, meaning a position in the list of content in the target content set that must be populated with an appropriate (e.g., to satisfy the topic, difficulty, and duration values, etc.)

The educational content system can select one or more subsets of units of content for each potential slot (e.g., to satisfy the topic distribution as described herein, etc.) in the list of content for the target content set. Furthering this example above, this can include selecting more than two potential units of content of “topic A” to populate the two remaining slots in the list of content for the target content set, where the potential units of content can each be associated with different difficulty values. The educational content system can select the potential units of content from the units of content having topic values that match those of the slot of interest (furthering the example above, “topic A”). The educational content system can select subsets of the units of content for each potential slot in the target content set. From the subsets of the units of content, the educational content system can select units of content for the unpopulated slots of the list of content in the target content set to satisfy the difficulty distribution and the duration value. As described herein above, the educational content system can maintain a running counter that is equal to the total durations of the units of content selected for inclusion in the target content set. Thus, using the current duration value of the target content set, the educational content system can select units of content from the subsets that allow for population of the unpopulated content slots without exceeding the target duration value (e.g., plus or minus a tolerance amount, such as 1%, 5%, 10%, 15%, etc.).

The units of content can be selected by the educational content system to populate the unpopulated slots in the list of content of the target content set to satisfy the target difficulty distribution. As described herein above, the target difficulty distribution can include an order, a frequency, or a density of particular question difficulties that should appear in the target content set. Thus, prior to selecting the units of content based on duration, the educational content system can filter each subset of potential units of content selected for each unpopulated slot to satisfy the difficulty distribution. For example, in some implementations, the difficulty distribution can be specified as particular difficulty values for each position in the target content set. In some implementations, the educational content system can filter the potential units of content for each slot in the target content set, such that the filtered potential units of content for each are associated with difficulty values specified for that slot. Thus, at this stage in the process, the educational content system can have filtered subsets of units of content that satisfy both the target topic distribution and the target difficulty distribution for potential inclusion in each slot of the target content set. For example, in some implementations, the educational content system may filter potential units of content based on other units of content (e.g. avoiding accidental combinations of serious and lighter topics, in some implementations); based on information about the user or client such as a location, language, etc. (e.g. locally-relevant content may be included, such as local monuments or buildings in educational content about architecture, while monuments or buildings from foreign locations may be excluded (or downgraded in importance or scoring, in some implementations). Other parameters may be used for filtering in various implementations, including real-time parameters, such as weather, time of day, etc. For example, content relevant to rainy weather (e.g. vocabulary items, discussions of the hydrologic cycle, etc.) may be filtered if the current weather at the user’s location is sunny while content relevant to the sun may be included (e.g. vocabulary items, discussions of solar cycles or the internal structure of the sun, etc.), or vice versa. Accordingly, content may be selected and/or filtered based on context, including surrounding content, real-time information about the user or their location, or any other such information.

The educational content system can then select units of content for each unpopulated slot in the target content set such that the selected units of content satisfy the duration distribution. For example, if the duration distribution is such that each slot in the content set has a specified duration, then the educational content system can select units of content from the filtered subsets of content that match (e.g., within a predetermined range, such as 1%, 5%, 10%, 15%, etc.) the duration values in the specified duration distribution. If the duration value is specified as a total duration value for the entire set, the educational content system 145 can iterate through each unpopulated slot in the target content set, and randomly (e.g., pseudo-randomly using a pseudo-random number generator, etc.) select a unit of content from the filtered subset of content for that slot. The duration value of the selected unit of content can be added to the current duration value of the target content set, and the educational content system can move to the next unpopulated slot in the target content set. The educational content system can further the filtered subsets of units of content to remove any units of content that have a duration value that exceeds the remaining duration value of the target content set (e.g., target duration for the target content set minus the current duration value for the target content set, etc.). In some implementations, the educational content system can estimate an average duration value for each remaining unpopulated slot in the target content set, and further filter each filtered subset of the units of content to remove units of content having duration values that exceed (e.g., within a predetermined range, such as 1%, 5%, 10%, 15%, etc.) the estimated average duration value. The educational content system can then select the units of content for each unpopulated slot as described above.

Once each content slot in the target content set has been populated with a unit of content, such that the target topic distribution, target difficulty distribution, and target duration values (or distribution) are satisfied, the educational content system can store the target content set in one or more data structures as part of the content sets in the database. The generated content set can be stored in association with a unique identifier, which can be returned to the computing device (e.g., the provider device or one or more client devices, etc.) that provided instructions to generate the content set. In some implementations, if the instructions received by the educational content system indicate that the target content set should be dynamically updated based on feedback information, the educational content system can store a copy of the generated content set in association with each of the profiles specified in the instructions.

The educational content system can present a requested content set (STEP 312). The educational content system can present each unit of content in a requested content set on a display of a computing device accessing the educational content system (e.g., one or more of the client devices, etc.). As described herein above, a client device can access the educational content system using authentication credentials associated with one of the profiles. Upon doing so, the educational content system can transmit display instructions to the accessing client device that cause the client device to present a user interface listing each content set that is accessible (e.g., stored in association with, assigned as described herein, etc.) by the respective profile. Each content set can be associated with an actionable object on the user interface that, when actuated (e.g., by user input to the client device, etc.), causes the client device to transmit a request for that content set to the educational content system. In response, the educational content system can access the requested content set and determine whether the requesting profile has access to the content set. If the requesting profile has access to the content set, the educational content system can access the first unit of content (e.g., the first in the ordered list, etc.) in the requested content set, and transmit display instructions to the client device that cause the client device to present the accessed unit of content in a user interface, as described herein. If the requesting profile does not have access to the content set, the educational content system can transmit an error message to the requesting client device, indicating that the requesting profile does not have permission to access the requested content set. The unit of content can be, for example, a question (e.g., a multiple-choice question, a fill-in-the-blank question, etc.) having a correct answer.

The display instructions can cause the unit of content to be displayed in one or user interfaces on the client device, such that one or more actionable objects (e.g., buttons or hyperlinks for multiple choice, a field for fill-in-the-blank, etc.) that allows a user to provide a proposed answer to the question. Upon entering in an answer, the display instructions can cause the client device to transmit the proposed answer to the question (e.g., the unit of content, etc.) to the educational content system. The proposed answer can accompany, for example, a request for the next unit of content in the content set.

The educational content system can receive the response to the question transmitted by the client device. If the response includes a proposed answer to the unit of content, the educational content system can compare the proposed answer to the correct answer for the unit of content. If the proposed answer is the correct answer, the educational content system can store an indication that the profile answered the unit of content correctly as part of the performance data for that profile. Otherwise, if the proposed answer is not the correct answer, the educational content system can store an indication that the user corresponding to the profile answered the unit of content incorrectly as part of the performance data for that profile. The indication of an incorrect or a correct answer (as the case may be) can be stored in the performance data as part of a historical response record for that question (e.g., unit of content), and any associated metadata (e.g., topic, difficulty, duration, etc.) for that question.

In some implementations, if the content set requested by the client device (e.g., the content set the client device is currently displaying, etc.) is indicated as a content set that should be dynamically updated based on feedback, the educational content system can update the content set based on one or more answers to the questions provided by the client device. In some implementations, the requested content set can be updated based on the performance data (e.g., including answers to questions in other content sets, etc.). For example, if the performance data for the provided content set indicates that a user answers one or more questions having an example “topic A” incorrectly, the educational content system can determine that this particular user needs more practice with questions having “topic A”, and update the topic distribution of the remaining content slots in the content set (e.g., and in some implementations, by increasing the number of content slots in the content set, etc.) to include at least one more question having “topic A”. To do so, the educational content system can select a new unit of content for the content set associated with the profile corresponding to the client device having the topic A, as described herein above (e.g., satisfying the difficulty and duration distribution, etc.). In some implementations, the newly selected unit of content can replace (e.g., at random, or a random question not having the same topic, etc.) another unit of content in the content set for the respective profile, effectively providing more exposure to “topic A” for that profile.

In some implementations, in response to receiving an indication of a correct or incorrect answer to a question in the requested content set, the educational content system can update the target difficulty distribution of the content set corresponding to the respective profile. For example, if a client device corresponding to the profile answers too many questions correctly, the educational content system can determine that the difficulty may need to be increased for the content set, and update the target difficulty values for the content slots in the content set. The educational content system can populate the remaining (e.g., unanswered, etc.) questions in the particular content set with updated units of content according to the new difficulty distribution. In some implementations, the educational content system can select a new unit of content in response to each answer to each question. In some implementations, the new unit of content can replace another unit of content specified for inclusion in the content set. After the content set has been updated based on the feedback (if needed), the educational content system can transmit the next unit of content in the requested content set to the client device, until all questions are answered and all other units of content (e.g., notes, etc.) have been accessed. Once all units of content in the content set have been answered or accessed, the educational content system can transmit a message to the client device indicating that the content set has been completed. The educational content system can store an indication that the content set has been completed by the respective profile in the performance data for that profile.

The educational content system can extract topic, difficulty, and duration information from a reference content set (STEP 314). The educational content system can generate the target topic distribution and the target complexity distribution for one or more cloned content sets (e.g., a content set that will be generated by the educational content system based on a reference set, etc.). For example, the educational content system can iterate through each unit of content referenced in the reference content set included in the instructions received from the provider device or one or more client devices, to identify complexity values and topic references for each unit of content in the reference content set. From the topic references (e.g., which can include subject matter references, topic category information, etc.) and the difficulty values associated with each question in the reference set (e.g., for questions, etc.), and the type information (e.g., question, note, etc.) in the reference content set, the educational content system can generate a topic distribution (e.g., an order, frequency, and density of particular topics appearing in the reference content set, etc.) and a difficulty distribution (e.g., an order, frequency, and density of particular question difficulties in the reference content set, etc.). A target duration value for the reference set can be determined by summing the individual duration values for each unit of content identified in the reference set.

The educational content system can generate a cloned set (STEP 316). In implementations where the instructions specify that a number of cloned content sets n should be generated, the educational content system can perform the steps detailed above in (STEP 310) generate a cloned content set using the target topic distribution, the target difficulty distribution, and target duration values extracted from the reference set. The cloned content set can be stored in the database in association with the reference content, from which the target topic distribution, target difficulty distribution, and target duration values were extracted, as described herein. In some implementations, the instructions can specify that only one or more specified portions of the reference content set (e.g., the topic distribution, the difficulty distribution, or the duration values, etc.) should be cloned, and the rest of the content set parameters can be explicitly specified in the instructions received by the instructions receiver. In such implementations, the cloned content sets can be generated as in (STEP 310) using the extracted parameters (e.g., topic distribution, difficulty distribution, duration, etc.) specified to cloned, and the parameters explicitly specified in the instructions that are not cloned from the reference set.

The educational content system can determine whether the number of generated cloned sets k is less than the number of specified cloned sets n (STEP 318). To determine whether all of the cloned content sets have been generated, the educational content system can compare the counter register k used to track the number of generated cloned content sets to the total number of requested cloned content sets n. If the counter register k is not equal to (e.g., less than) the total number of requested content sets n, the educational content system can execute (STEP 320). If the counter register k is equal to (e.g., equal to or greater than) the total number of requested content cloned sets n, the educational content system can execute (STEP 312).

The educational content system can increment the counter register k (STEP 320). To track the total number of cloned content sets that are generated, the educational content system can add one to the counter register k to indicate the number of cloned content sets that have been generated by the educational content system. After incrementing the value of the counter register k, the educational content system can execute (STEP 316).

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus”, “data processing system”, “client device”, “computing platform”, “computing device”, or “device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the educational content system 205 can include clients and servers. For example, the educational content system 205 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving input from a user interacting with the client device). Data generated at the client device (e.g., a result of an interaction, computation, or any other event or computation) can be received from the client device at the server, and vice-versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the educational content system 205 could be a single module, a logic device having one or more processing modules, one or more servers, or part of a search engine.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided may be useful for generating dynamic content sets based on real-time feedback, the systems and methods described herein may be applied to other environments. The foregoing implementations are illustrative rather than limiting of the described systems and methods. The scope of the systems and methods described herein may thus be indicated by the appended claims, rather than the foregoing description, and changes that come within the meaning and range of equivalency of the claims are embraced therein.

What is claimed is:

1. A method of generating dynamic content sets based on real-time feedback, comprising:
maintaining, by one or more processors coupled to memory, a plurality of atomic units of content, each atomic unit of content corresponding to a topic and a complexity score;
maintaining, by the one or more processors, a client device profile corresponding to a client device, the client device profile comprising historical response records for at least one of the plurality of atomic units of content;
receiving, by the one or more processors, from a provider computing device, instructions for generation of a dynamic set of content, the instructions comprising topic distribution information and complexity distribution information;
generating, by the one or more processors, based on the instructions comprising the topic distribution information and the complexity distribution information, the dynamic set of content as a subset of the plurality of atomic units of content; and
presenting, by the one or more processors, based on the client device profile, on a display of the client device, an item of the dynamic set of content, responsive to a request for the dynamic set of content received from the client device.

2. The method of claim 1, wherein maintaining the plurality of atomic units of content comprises:
receiving, by the one or more processors, from the provider computing device, a request to add an atomic unit of content, the request comprising the atomic unit of content, the topic of the atomic unit of content, and the complexity score of the atomic unit of content; and
storing, by the one or more processors, the atomic unit of content as part of the plurality of atomic units of content, such that the atomic unit of content is stored in association with the topic of the atomic unit of content and the complexity score of the atomic unit of content.

3. The method of claim 1, further comprising:
receiving, by the one or more processors, from the client device, a response to the presentation of the dynamic set of content; and
updating, by the one or more processors, the historical response records of the client device profile corresponding to the client device based on the response.

4. The method of claim 3, wherein the presentation of the dynamic set of content includes a question having a correct answer;
wherein receiving the response from the client device comprises receiving a provided answer to the question presented on the display of the client device; and
wherein updating the client device profile comprises updating the client device profile to include an indication of whether the provided answer matches the correct answer for the question.

5. The method of claim 1, wherein receiving the instructions for generation of the dynamic set of content comprises receiving, by the one or more processors, a reference set of atomic units of content from the provider computing device, each of the reference set of atomic units of content comprising a respective reference topic, a respective reference complexity score, and a respective content format.

6. The method of claim 5, wherein generating the dynamic set of content further comprises:
identifying, by the one or more processors, a reference subset of the reference set of atomic units of content, the respective content format of each item of the reference subset matching a question format;
determining, by the one or more processors, from the respective reference complexity score of each item of the reference set, a target complexity score distribution and a target duration value; and
generating, by the one or more processors, the dynamic set of content by selecting a target subset of the plurality of atomic units of content, such that items of the target subset satisfy the target duration value and the target complexity score distribution.

7. The method of claim 6, wherein the generating the dynamic set of content is further based on selecting the target subset of the plurality of atomic units of content such that each item of the target subset corresponds to a target topic specified by the provider computing device.

8. The method of claim 1, wherein receiving the instructions for generation of the dynamic set of content further comprises receiving, by the one or more processors, from the provider computing device, a distribution of topics, a distribution of complexity scores, and an identifier of the client device profile.

9. The method of claim 8, wherein generating the dynamic set of content further comprises:
generating, by the one or more processors, based on the client device profile, an initial dynamic set of content selected as an initial subset of the plurality of atomic units of content, such that items of the initial dynamic set of content satisfy the distribution of topics and the distribution of complexity scores;
presenting, by the one or more processors, the initial dynamic set of content on the display of the client device corresponding to the client device profile; and
updating, by the one or more processors, the initial dynamic set of content based on a response to the presentation of the initial dynamic set of content received from the client device.

10. The method of claim 9, wherein updating the initial dynamic set of content comprises:
updating, by the one or more processors, the distribution of complexity scores based on the response to the presentation of the initial dynamic set of content received from the client device; and
replacing, by the one or more processors, at least one of the initial dynamic set of content based on the updated distribution of complexity scores.

11. A system for generating dynamic content sets based on real-time feedback, comprising:
one or more processors coupled to memory, the one or more processors configured to:
maintain a plurality of atomic units of content, each atomic unit of content corresponding to a topic and a complexity score;
maintain a client device profile corresponding to a client device, the client device profile comprising historical response records for at least one of the plurality of atomic units of content;
receive, from a provider computing device, instructions for generation of a dynamic set of content, the instructions comprising topic distribution information and complexity distribution information;
generate, based on the instructions comprising the topic distribution information and the complexity distribution information, the dynamic set of content as a subset of the plurality of atomic units of content; and
present, based on the client device profile, on a display of the client device, an item of the dynamic set of content, responsive to a request for the dynamic set of content received from the client device.

12. The system of claim 11, wherein the one or more processors are further configured to maintain the plurality of atomic units of content by:
receiving, from the provider computing device, a request to add an atomic unit of content, the request comprising the atomic unit of content, the topic of the atomic unit of content, and the complexity score of the atomic unit of content; and
storing the atomic unit of content as part of the plurality of atomic units of content, such that the atomic unit of content is stored in association with the topic of the atomic unit of content and the complexity score of the atomic unit of content.

13. The system of claim 11, wherein the one or more processors are further configured to:
receive, from the client device, a response to the presentation of the dynamic set of content; and
update the historical response records of the client device profile corresponding to the client device based on the response.

14. The system of claim 13, wherein the presentation of the dynamic set of content includes a question having a correct answer, and wherein the one or more processors are further configured to receive the response from the client device by receiving a provided answer to the question presented on the display of the client device; and
wherein the one or more processors are further configured to update the client device profile by updating the client device profile to include an indication of whether the provided answer matches the correct answer for the question.

15. The system of claim 11, wherein the one or more processors are further configured to receive the instructions for generation of the dynamic set of content by receiving a reference set of atomic units of content from the provider computing device, each of the reference set of atomic units of content comprising a respective reference topic, a respective reference complexity score, and a respective content format.

16. The system of claim 15, wherein the one or more processors are further configured to generate the dynamic set of content by:
identifying a reference subset of the reference set of atomic units of content, the respective content format of each item of the reference subset matching a question format;
determining, from the respective reference complexity score of each item of the reference set, a target complexity score distribution and a target duration value; and
generating the dynamic set of content by selecting a target subset of the plurality of atomic units of content, such that items of the target subset satisfy the target duration value and the target complexity score distribution.

17. The system of claim 16, wherein the one or more processors are further configured to generate the dynamic set of content further based on selecting the target subset of the plurality of atomic units of content such that each item of the target subset corresponds to a target topic specified by the provider computing device.

18. The system of claim 11, wherein the one or more processors are further configured to receive the instructions for generation of the dynamic set of content by receiving, from the provider computing device, a distribution of topics, a distribution of complexity scores, and an identifier of the client device profile.

19. The system of claim 18, wherein the one or more processors are further configured to generate the dynamic set of content by:
generating, based on the client device profile, an initial dynamic set of content selected as an initial subset of the plurality of atomic units of content, such that items of the initial dynamic set of content satisfy the distribution of topics and the distribution of complexity scores;
presenting the initial dynamic set of content on the display of the client device corresponding to the client device profile; and
updating the initial dynamic set of content based on a response to the presentation of the initial dynamic set of content received from the client device.

20. The system of claim 19, wherein the one or more processors are further configured to update the initial dynamic set of content by:
updating the distribution of complexity scores based on the response to the presentation of the initial dynamic set of content received from the client device; and
replacing at least one of the initial dynamic set of content based on the updated distribution of complexity scores.
